(19) United States
(12) Patent Application Publication
(10) Pub. No.: US 2010/0094847 A1
(43) Pub. Date: Apr. 15, 2010

(54) METHOD AND APPARATUS FOR MULTIPLE-PROTOCOL ACCESS TO OBJECT-BASED STORAGE

(76) Inventors: Steven J. Malan, Virginia Beach, VA (US); Frank G. Logan, III, Virginia Beach, VA (US); Patrick J. Kelsey, Manheim, PA (US); Edward S. Quicksall, Ponte Vedra Beach, FL (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/395,767

(22) Filed: Mar. 2, 2009

Related U.S. Application Data
(60) Provisional application No. 61/104,441, filed on Oct. 10, 2008.

(51) Int. Cl. G06F 17/30

(52) U.S. Cl. 707/705; 707/E17.055; 707/E17.001

(57) ABSTRACT

In one embodiment, an apparatus includes a storage presentation module and a mapping module in communication with the storage presentation module and an object pool module. The storage presentation module is operable to provide a first storage interface and a second storage interface via a network interface. The first storage interface is associated with a first storage resource accessible via a first storage protocol, and the second storage interface is associated with a second storage resource accessible via a second storage protocol different from the first storage protocol. The mapping module is operable to receive from the storage presentation module a request for access to the first storage resource based on the first storage protocol and a request for access to the second storage resource based on the second storage protocol. The mapping module is operable to convert the request for access to the first storage resource into a request for access to a first object in the object pool module, the first object is associated with the first storage resource. The mapping module is operable to convert the request for access to the second storage resource into a request for access to a second object in the object pool module, the second object is associated with the second storage resource.

### CROSS-REFERENCE TO RELATED APPLICATION

This application claims priority to U.S. Patent Application Ser. No. 61/104,441, filed Oct. 10, 2008, and entitled “METHODS AND APPARATUS FOR MULTIPLE-PROTOCOL ACCESS TO OBJECT-BASED STORAGE,” which is incorporated herein by reference in its entirety.

### BACKGROUND

Embodiments described herein relate generally to access to data including, for example, access to data in object-based storage using multiple protocols. Furthermore, embodiments described herein relate to access to data in object-based storage using multiple protocols over a network.

Data in computer systems have historically been stored on block devices such as hard disk drives. Block devices are formatted into fixed-size sectors and a file system provides logical access to structures such as files and directories that are stored across the sectors of a block device. Recently, object-based storage devices (“OSD”) have been developed that are capable of storing and accessing data based on natively variable-size objects, rather than fixed size blocks. Unlike blocks, objects can be used to store entire data structures such as files, database tables, images, etc.

Various protocols can be used to access data over a network such as a computer network. For example, the Internet Small Computer System Interface (“iSCSI”) protocol, the Network File System (“NFS”) protocol, the Common Internet File System (“CIFS”), and the Hypertext Transfer Protocol (“HTTP”) can be used to access data over a network.

Known methods and devices to access data over a network suffer several disadvantages. For example, known methods and systems typically provide for a limited number of protocols. Additionally, known methods and systems typically fail to provide encapsulation and protection of data and native access to data by multiple protocols.

### SUMMARY OF THE INVENTION

In one embodiment, an apparatus includes a storage presentation module and a mapping module in communication with the storage presentation module and an object pool module. The storage presentation module is operable to provide a first storage interface and a second storage interface via a network interface. The first storage interface is associated with a first storage resource accessible via a first storage protocol, and the second storage interface is associated with a second storage resource accessible via a second storage protocol different from the first storage protocol. The mapping module is operable to receive from the storage presentation module a request for access to the first storage resource based on the first storage protocol and a request for access to the second storage resource based on the second storage protocol. The mapping module is operable to convert the request for access to the first storage resource into a request for access to a first object in the object pool module, the first object is associated with the first storage resource. The mapping module is operable to convert the request for access to the second storage resource into a request for access to a second object in the object pool module, the second object is associated with the second storage resource.

### BRIEF DESCRIPTION OF THE DRAWINGS

FIG. 1 is an illustration of a multiple-protocol object-based storage device in communication with a group of clients via a network, according to an embodiment.

FIG. 2 is a system block diagram of a multiple-protocol object-based storage device, according to an embodiment.

FIG. 3 is an illustration of block-based storage, according to an embodiment.

FIG. 4 is an illustration of object-based storage, according to an embodiment.

FIG. 5 is an illustration of an object in object-based storage, according to an embodiment.

FIG. 6 is a system block-diagram of another multiple-protocol object-based storage device, according to another embodiment.

FIG. 7 illustrates a communication flow for providing access in a multiple-protocol object-based storage device to data related to a storage resource, according to an embodiment.

FIG. 8 illustrates another communication flow for providing access in a multiple-protocol object-based storage device to data related to a storage resource, according to another embodiment.

FIG. 9 is a block diagram of a process for multiple-protocol access to object-based storage, according to an embodiment.

FIG. 10 is a system block diagram of another multiple-protocol object-based storage device in communication with a group of clients via a network, according to another embodiment.

### DETAILED DESCRIPTION

Object-based storage has many advantages over traditional block-based storage. Object-based storage can improve device and data sharing. Metadata at the storage device can be platform independent and opaque to users of the system. Furthermore, systems hosting object-based storage are required only to cooperate in naming (e.g., referencing objects based on object identifiers such as unique numbers or names), and only minimally or not at all in storage management.

Additionally, object-based storage can offer improved scalability and performance over traditional storage methods. In some embodiments, object-based storage can distribute client requests across many devices. This can improve storage and device resource allocation and quality of service (“QoS”), for example. For example, computationally intensive storage tasks can be offloaded from a host (such as a personal computer) to a storage device. Furthermore, object-based storage can provide efficient snapshots of data, data cloning, and data migration.

In some embodiments, a network appliance such as a network storage device can receive and process requests for access to data in a variety of types of storage resources via a group of protocols. The network appliance can map the requests for access to different types of storage to data objects representing the various types of storage resources in a common object pool.

For example, a network storage device including an object-based storage device can be coupled to a first computer and a second computer via a network. The network storage device can include a web server configured to host a web site as files and directories accessible to an Internet browser running on the first computer. Additionally, the network storage device can provide an interface for saving data from the second computer to the network storage device as a backup tape. However, the network storage device does not include a backup tape medium (or tape storage resource), or a file system of files and directories (or file-based storage resource). Rather, the object-based storage device of the network storage device includes data objects that represent the backup tape and the files and directories of the web site. In other words, the backup tape and the files and directories of the web site are virtualized by the objects in the object-based storage device.

A user of the first computer can request access to the files including the web pages of the web site via the Internet browser running on the first computer. Under the direction of the user and according to the Hypertext Transfer Protocol (“HTTP”), the Internet browser requests the files that correspond to a particular web page. The network storage device receives the request for the files, and converts the request for the files into a request for data stored in an object representing the files (or a directory including the files). The data corresponding to the requested files is then formatted to appear to be the requested files and provided to the Internet browser. The Internet browser receives the files and displays the requested web page.

Similarly, the user of the second computer directs a backup application running on the second computer to make a backup copy of the hard drive of the second computer on a tape at the network storage device, and the application proceeds to make the backup based on a backup protocol to copy the contents of the hard drive to the tape. Each time the application running on the second computer requests to write data to the backup tape, the network storage device converts the request to write data to the backup tape into a request to write data to an object in the object-based storage device. The network storage device then responds to the application as though the network storage device had written the data to the backup tape.

Such network storage devices and related methods allow clients (computers, applications, and users of computers and applications) to benefit from advancements of object-based storage devices without altering or modifying applications or computer data connections. Additionally, network storage devices and related methods disclosed herein simplify management of various types of storage resources by virtualizing a variety of different storage resources into common (similarly or identically formatted objects) such that common management tasks including data backup, data de-duplication, and data cloning can be performed commonly for the different storage resources.

As used in this specification, the singular forms “a,” “an” and “the” include plural referents unless the context clearly dictates otherwise. Thus, for example, the term “a client” is intended to mean a single client or a combination of clients, “network appliance” is intended to mean one or more network appliances, or a combination thereof.

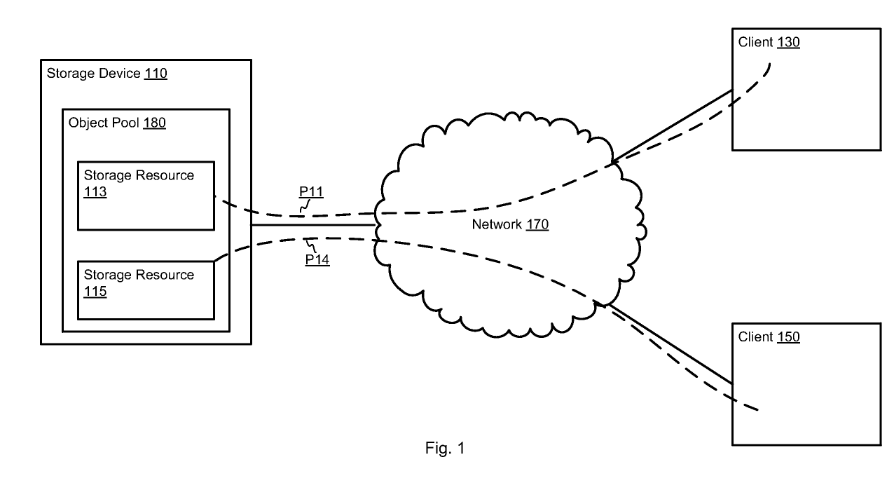

FIG. 1 is an illustration of a multiple-protocol object-based storage device in communication with a group of clients via a network, according to an embodiment. Client 130 and client 150 are operatively coupled to multiple-protocol object-based storage device (also referred to herein as “storage device” for simplicity of reference) 110 is operatively via network 170. Clients 130 and 150 can be any devices capable of communicating with storage device 110 via a network. In some embodiments, client 130 and/or client 150 can be a computer terminal such as personal computers, laptop or notebook computers, computer servers such as web servers and/or database servers, and/or handheld computer terminals. In some embodiments client 130 and/or client 150 can be, a handheld devices such as a cellular telephone device, a cellular smartphone device, a personal digital (or data) assistant (“PDA”), or some other handheld device operatively coupled to network 170.

In some embodiments, network 170 is a combination of two or more networks. In some embodiments, network 170 is a combination of two or more homogeneous networks. In other words, network 170 can be multiple similar networks operatively coupled one to another via one or more network switches, routers, gateways, or other devices. In some embodiments, network 170 is a combination of two or more heterogeneous networks. For example, network 170 can be a combination of a wireless local area network (“LAN”), a wired LAN, a wireless wide area network (“WWAN”) such as a cellular data network, a storage area network (“SAN”), and Ethernet network, a TCP/IP network, a fiber channel fabric, and a SCSI bus coupled one to another via one or more network switches, routers, gateways, bridges, or other devices. In some embodiment, two or more network can be coupled via another network. For example, a WWAN can be coupled to a wired LAN via the Internet.

In some embodiments, client 130, client 150, and storage device 110 are operatively coupled to network 170 via homogeneous network connections. For example, network 170 can be a LAN, a wide area network (“WAN”), or a SAN to which each of client 130, client 150, and storage device 110 are operatively coupled via a common type (of class) of network connection such as an Ethernet connection or a fiber channel connection. In some embodiments, client 130, client 150, and storage device 110 are operatively coupled to network 170 via heterogeneous network connections. For example, client 130 can be a smartphone operatively coupled to a WWAN such as a cellular data network; client 150 can be a computer terminal operatively coupled to a wired LAN via an Ethernet connection; storage device 110 can be operatively coupled to a SAN via a fiber channel connection; and the WWAN, the wired LAN, and the SAN can be operatively coupled via the Internet.

Storage device 110 includes object pool 180. Object pool 180 can be a logical collection of storage objects each including one or more storage resources. In some embodiments, object pool 180 can provide common management functionalities such as data backup, data de-duplication, data migration, and data access for the objects in object pool 180. In some embodiments, object pool 180 can provide generic or uniform access to objects (or data objects) representing various different types of storage resources. Said differently, objects can represent a storage resource because they include or contain the data of the storage resources. Additionally, objects can include attributes or properties configured or set to indicate, for example, what type of storage resource is represented or properties including formatting, logical partitioning, size, and/or other properties of the represented storage resources. For example, object pool 180 can include objects representing (or including the data of) block-based storage resources such as block-based storage disks; file-based storage resources such as block-based file systems or volumes; serial-access (or sequential access) storage resources such as data tape drives; tape library storage resources; optical storage resources such as a compact disk (“CD”), a digital versatile or video disk (“DVD”), a CD drive, a DVD drive, and/or libraries of optical storage resources; object-based storage resources such as Small Computer System Interface (“SCSI”) object-based storage devices (“OSDs”); and/or other storage resources. In some embodiments, storage resources represented by objects in object pool 180 can be referred to as virtual storage resources. In some embodiments, object pool 180 can include objects stored on one or more object-based physical storage devices.

As illustrated in FIG. 1, storage resource 113 of storage device 110 is accessible to client 130 via protocol P11. Also as illustrated in FIG. 1, storage resource 115 of storage device 110 is accessible to client 150 via protocol P14. A protocol can be a convention or standard that enables clients 130 and 150 to communicate with storage device 110 via network 170. In other words, protocols P11 and P14 can define the syntax, symbols, semantics, and/or synchronization of data, metadata, and/or control for data transfer between, for example, client 130 and storage device 110, and client 150 and storage device 110, respectively. For example, protocols P11 and P14 can be the Internet Small Computer System Interconnect (“iSCSI”) protocol, the Common Internet File System (“CIFS”), the Network File System (“NFS”), the Apple™ Filing Protocol (“AFP”), the Hypertext Transfer Protocol (“HTTP”), the Web-based Distributed Authoring and Versioning Protocol (“WebDAV”), the File Transfer Protocol (“FTP”), and/or other standardized or proprietary protocols.

Storage device 110 can receive requests for access to storage resource 113 from client 130 based on protocol P11, and requests for access to storage device 115 from client 150 based on protocol P14. Access to a storage resource can include for example, reading data from the storage resource, writing data to the storage resource, reading or changing an attribute or parameter of a storage resource, reading or writing metadata related to data in a storage resource, and/or other access to a storage resource. Storage device 110 can be configured to map or convert those requests for access to storage resource 113 and 115 to requests for access to data stored in objects in object pool 180. Storage device 110 can access the data related to storage resource 113 and 115 in one or more objects in object pool 180, and provide a response to client 130 and client 150, respectively, via protocols P11 and P14, respectively. In other words, a client can request access to one or more storage resources (or data included in one or more storage resources) via a protocol related to the one or more storage resource, and a storage device can access one or more objects representing the one or more storage resources contained in an object pool and provide the client with the access to the data via the protocol.

For example, a client can request from a multiple-protocol object-based storage device a file within a file system of a disk volume via HTTP. Said differently, a client such as an Internet browser running on a computer terminal can issue a GET HTTP command to a multiple-protocol object-based storage device for a file. The disk volume can be represented as an object in an object pool of the multiple-protocol object-based storage device. In other words, the object includes the data of the disk volume, but does not include the physical disk including the logical volume. Additionally, in some embodiments, the data in the object is not formatted as a disk volume or file system. The multiple-protocol object-based storage device is configured to convert the HTTP request for the file to a request for access to the portion of data in the object that represents the file (or the data contained in the requested file). The multiple-protocol object-based storage device can read the data from the object and provide the data to the client via HTTP. In other words, the multiple-protocol object-based storage device can provide the data to the client as a response to an HTTP GET request. Thus, the client need not provide any commands related to the object pool or storage of data as objects, because the client accesses the storage resources of the multiple-protocol object-based storage device natively (or as storage resources) rather than as objects representing the storage resources. This allows a single storage device to provide access to multiple types (or categories) of storage resources without having to manage each type individually. Rather, each type of storage resource represented by an object in the multiple-protocol object-based storage device is commonly managed (e.g., data management such as data de-duplication, migration, and security) with the other types of storage resources represented by objects in an object pool of the multiple-protocol object-based storage device.

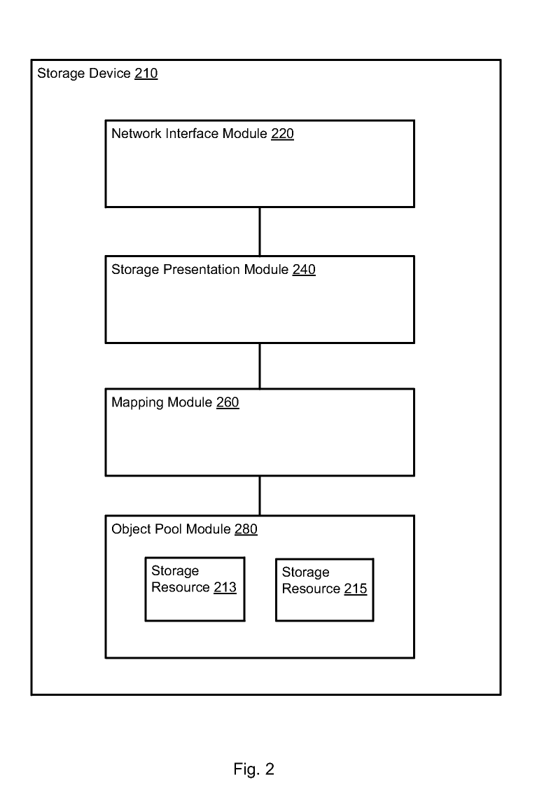

FIG. 2 is a system block diagram of a multiple-protocol object-based storage device, according to an embodiment. Storage device 210 includes network interface module 220, storage presentation module 240, mapping module 260, and object pool module 280. Network interface module 220 is operatively coupled to storage presentation module 240; storage presentation module 240 is operatively coupled to mapping module 260; and mapping module 260 is operatively coupled to object pool module 280. In some embodiments, network interface module 220, storage presentation module 240, mapping module 260, and object pool module 280 can be software modules embodied in software or code executable on a processor. In some embodiments, network interface module 220, storage presentation module 240, mapping module 260, and object pool module 280 can be hardware modules such as application specific integrated circuits (“ASICs”) or other hardware configured to operate or function as network interface module 220, storage presentation module 240, mapping module 260, and/or object pool module 280. In some embodiments, one or more of network interface module 220, storage presentation module 240, mapping module 260, and object pool module 280 are software modules and other of network interface module 220, storage presentation module 240, mapping module 260, and object pool module 280 are hardware modules. In some embodiments, one or more of network interface module 220, storage presentation module 240, mapping module 260, and object pool module 280 can be a hybrid software and hardware module. For example, a portion of network interface module 220 can be implemented (or realized) in a hardware module such as a physical layer transceiver, and a portion of network interface module 220 can be implemented as a software module (such as a software-based network protocol stack) executable on a processor operatively coupled to the hardware module.

Network interface module 220 can be configured to operatively couple storage device 210 to a network. For example, network interface module 220 can be a network interface card (“NIC”) such as an Ethernet LAN card, a fiber channel card, or a wireless network adapter. In some embodiments, network interface module 220 is configured to operatively couple storage device 210 to a network via an Ethernet connection. In some embodiments, network interface module 220 is configured to operatively couple storage device 210 to a network via a fiber channel connection.

In some embodiments, network interface module 220 is configured to operatively couple storage device 210 to two or more networks. For example, network interface module 220 can include multiple (physical) network ports, and can be operatively coupled (and, thus, operatively couple storage device 210) to multiple networks via the multiple network ports simultaneously. In some embodiments, network interface module 220 can be operatively coupled to two or more homogeneous networks. Said differently, in some embodiments, network interface module 220 can be operatively coupled to two or more similar networks (or networks based on similar protocols). In some embodiments, network interface module 220 can be operatively coupled to two or more heterogeneous networks. In other words, in some embodiments, network interface module 220 can be operatively coupled to two or more different networks (or networks based on different protocols).

Storage presentation module 240 is operatively coupled to network interface module 220 and is configured to present one or more storage interfaces to a network via network interface module 220. A storage interface can, for example, expose (or provide access to) a storage resource based on a protocol that provides access to a storage resource or a data in a storage resource. In other words, storage presentation module 240 is configured to communicate based on a variety of protocols with one or more clients operatively coupled to storage device 210 via network interface module 220. More specifically, for example, a storage interface can be a file-based interface such as CIFS, NFS, AFP, WebDAV, FTP, or other file-based interfaces or protocols. Additionally, a storage interface can be, for example, a block-based interface such as SCSI block commands (“SBCs”) over iSCSI or other block-based interfaces or protocols. A storage interface can also be, for example, an object-based interface such as SCSI object-based storage device (“OSD”) commands over iSCSI or other object-based interfaces or protocols. Furthermore, an interface can be other interfaces or protocols such as, for example, SCSI stream commands (“SSCs”) and/or SCSI media changer (“SMC”) commands over iSCSI. In some embodiments, storage presentation module 240 can advertise or broadcast a storage interface via network. In other words, storage presentation module 240 can notify devices operatively coupled to a network of a storage interface or a storage resource accessible via a storage interface at storage device 210.

In some embodiments, storage presentation module 240 can be configured to communicate with the clients natively via various storage interfaces. In other words, storage presentation module 240 can communicate with clients via the protocols as though storage presentation module 240 was operatively coupled to the storage resources presented by the storage interfaces. For example, storage presentation module 240 can expose an iSCSI interface to a storage resource such as a block-based disk represented by an object in an object pool via network. Clients can provide standard SBCs to storage device 210, and storage device 210 can provide standard responses to the SBC via storage presentation module 240.

In some embodiments, storage presentation module 240 can be configured to communicate with a group of clients via single or common interface. In other words, each client from a group of clients can share an interface of storage presentation module 240. Said differently, an interface can have a one-to-many relationship with a group of clients. In some embodiments, storage presentation module 240 can present or export an interface to each client from a group of clients. Said differently, in some embodiments, storage presentation module 240 can be configured to present a group of interfaces to a group of clients such that a unique interface is presented to each client from a group of clients. In other words, an interface can have a one-to-one relationship with a client. In some embodiments, an interface from a group of interface presented by storage presentation module 240 can be based on a protocol different from the protocols of the other interfaces from the group of interfaces.

Storage presentation module 240 communicates with clients via various protocols associated with the storage interfaces exposed (or presented) by storage presentation module 240, and provides the requests for access to storage resources received from the clients to mapping module 260. Mapping module 260 is configured to receive the requests for access to storage resources from storage presentation module 240, and convert or map those requests to requests for access to objects in object pool module 280. In some embodiments, an object in object pool module 280 includes attributes and/or other data related to a storage resource represented by that object. For example, an object can include attributes related to formatting, directory structure, logical volumes, and/or other data related to a storage resource represented by the object. In some embodiments, mapping module 280 can access such attributes to map or convert a request for access to a storage resource to a request for access to an object.

After converting or mapping a request for access to a storage resource to a request for data in an object (or object data), mapping module 260 requests the object data from one or more objects in object pool module 280. Object pool module 280 accesses the object data (e.g., reads data from or writes data to an object), and provides a status response to mapping module 260. For example, if the request for access to object data is a request to write data to an object, object pool module 280 can write the data to, for example, an object representing storage resource 213, and provide a response to mapping module 260 indicating that the write operation was successful or failed. Similarly, if the request for access to object data is a request to read data from an object, object pool module can read the data from, for example, an object representing storage resource 215, and provide a response to mapping module 260 indicating that the read operation was successful (or failed) and including any data read from the object.

Mapping module 260 is configured to map or convert responses from object pool module 280 to responses to the requests for access to storage resources received from clients via the various protocols. In other words mapping module 260 converts the responses to requests for object data to responses to requests for access to storage resources. Additionally, mapping module 260 provides the responses to requests for access to storage resources to storage presentation module 240. Storage presentation module 240 provides the responses to requests for access to storage resources to clients via the same storage interface (or protocol) via which the requests for access to storage resources were received.

In some embodiments, mapping module 260 can be configured to include a group of mapping sub-modules. Each mapping sub-module can be configured to communicate with an interface from a group of interfaces exported by storage presentation module 240, to receive requests for access to storage resources from that interface, and convert or map those requests to requests for access to objects in object pool module 280. Said differently, in some embodiments, mapping module 260 can be configured to have a group of mapping sub-modules such that each mapping sub-module communicates with a unique interface presented by storage presentation module 240. In other words, an interface can have a one-to-one relationship with a mapping sub-module. This can prevent, for example, clients operatively coupled to or in communication with the interfaces from interfering one with another. Said differently, such an arrangement can provide isolation between the clients and the requests for access to storage resources send from those clients within a multiple-protocol object-based storage device. For example, mapping module 260, storage presentation module 240, and/or object pool module 280 can reserve or lock (e.g., using semaphores or mutual exclusion (“mutex”) locks) objects within object pool module 280 such that one request for access to a particular storage resource waits of is delayed by mapping module 260, storage presentation module 240, and/or object pool module 280 until a prior request for access to that storage resource is complete.

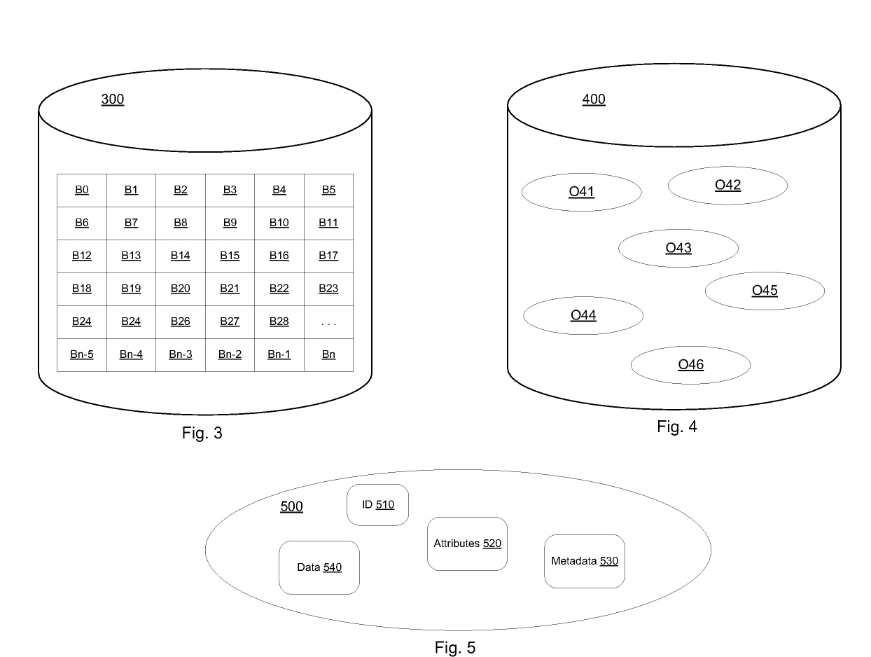

As discussed above, a multiple-protocol object-based storage device can provide access to storage resources represented by objects in an object pool including one or more object-based storage devices or disks. FIG. 3 is an illustration of block-based storage, according to an embodiment. Block-based storage (also referred to as traditional block-based storage) is generally provisioned or partitioned as a contiguous sequence of blocks or sectors of storage space on a storage device or disk. As illustrated in FIG. 3, block-based storage device 300 includes blocks labeled B0 through Bn. A file system is overlaid on the partitioned blocks of a block-based storage device by the host system (e.g., a personal computer or computer server operatively coupled to the block-based storage device), and files, directories, metadata, and attributes (e.g., file attributes and directory attributes) are stored in blocks of the block-based storage device. Files, directories, metadata, and/or attributes that cannot be contained in a single block are spread across multiple linked blocks. The file system manages the hierarchy or directories, files, metadata, and attributes, and the block-level storage of the files, directories, metadata, and attributes. Concurrent management of these tasks can be resource intensive, inefficient, and complex. Furthermore, it can be difficult and inefficient to store or manage data sets such as virtual storage resources because a file system does not natively support structures other than directories, files, metadata, and attributes.

In contrast, object-based storage manages data in objects. FIG. 4 is an illustration of object-based storage, according to an embodiment. As illustrated in FIG. 4, object-based storage device 400 includes objects labeled O41 through O46. Objects labeled O41 through O46 lack the hierarchical structure of a file system, and are instead natively referenced by an object ID. In other words, an object exists in object-based storage as the object itself and can be accessed individually based on the object's ID. FIG. 5 is an illustration of an object in object-based storage, according to an embodiment. As illustrated in FIG. 5, object 500 includes ID (or object ID or identifier) 510, attributes 520, metadata 530, and data 540. Because objects in object-based storage are each simply an organization of related data (e.g., attributes, metadata, and user data), storage resources can be represented (or virtualized) in the objects of a object-based storage much more simply than in the hierarchical structure of the directories and files of a file system.

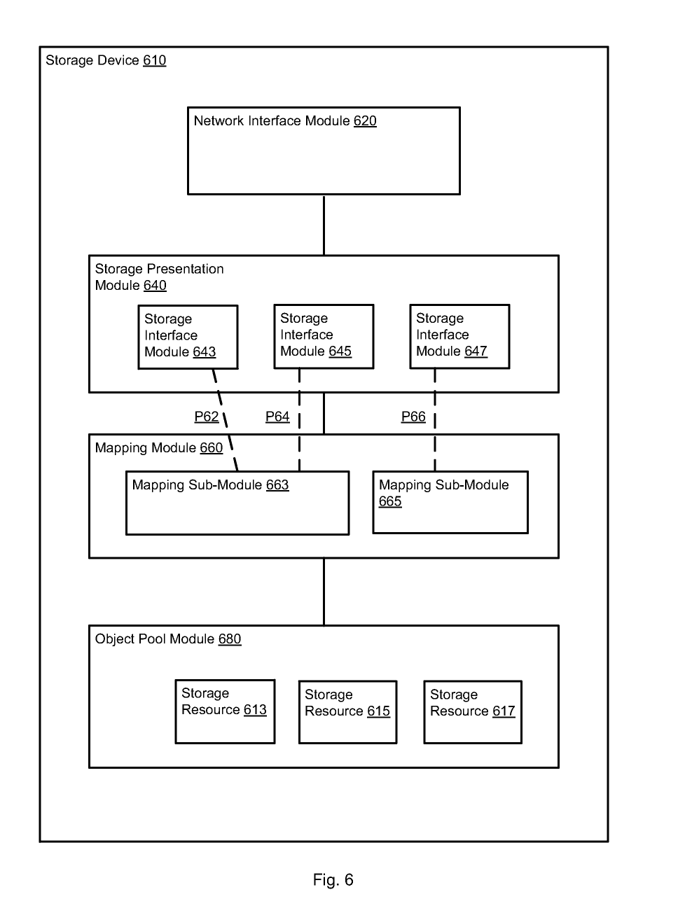

FIG. 6 is a system block-diagram of another multiple-protocol object-based storage device, according to another embodiment. Storage device 610 includes network interface module 620, storage presentation module 640, mapping module 660, and object pool module 680. Network interface module 620 is operatively coupled to storage presentation module 640; storage presentation module 640 is operatively coupled to mapping module 660; and mapping module 660 is operatively coupled to object pool module 680. In some embodiments, network interface module 620, storage presentation module 640, mapping module 660, and object pool module 680 can be software modules embodied in software or code executable on a processor. In some embodiments, network interface module 620, storage presentation module 640, mapping module 660, and object pool module 680 can be hardware modules such as ASICs or other hardware configured to operate or function as network interface module 620, storage presentation module 640, mapping module 660, and/or object pool module 680. In some embodiments, one or more of network interface module 620, storage presentation module 640, mapping module 660, and object pool module 680 are software modules and other of network interface module 620, storage presentation module 640, mapping module 660, and object pool module 680 are hardware modules. In some embodiments, one or more of network interface module 620, storage presentation module 640, mapping module 660, and object pool module 680 can be a hybrid software and hardware module. For example, a portion of network interface module 620 can be implemented (or realized) in a hardware module such as a physical layer transceiver, and a portion of network interface module 620 can be implemented as a software module (such as a software-based network protocol stack) executable on a processor operatively coupled to the hardware module.

Similar to network interface module 220 discussed in relation to FIG. 2, network interface module 620 can be configured to the operatively coupled to one or more networks. Thus, storage device 610 can be operatively coupled to one or more networks via network interface module. For example, network interface module 620 can include one or more NICs or other network adapters compatible with one or more networks.

Storage presentation module 640 is similar to storage presentation module 240 discussed in relation to FIG. 2. Storage presentation module 640 is operatively coupled to network interface module 620 and can be configured to expose or present one or more storage interfaces related to storage resources to a network (or to devices or clients operatively coupled to a network). Storage presentation module 640 further receives requests for access to storage resources from clients via network interface module 620, an provides those requests to mapping module 660. As illustrated in FIG. 6, in some embodiments, storage presentation module 640 includes storage interface module 643, storage interface module 645, and storage interface module 647. Storage interface modules 643, 645, and 647 can be hardware modules, software modules, or a combination of hardware and software modules configurable to expose one or more storage interfaces to clients (e.g., computer terminals) via a network.

In some embodiments, storage interface modules 643, 645, and 647 are protocol or interface specific. In other words, in some embodiments, a storage interface module is configured to expose only a single storage interface. In some embodiments, storage interface modules 643, 645, and 647 are configurable such that a single storage interface module can expose one interface at one time, and another interface at another time. Thus, storage device 610 can be configurable to expose various types of storage interface depending on, for example, a number of requests at a particular type of storage interface, a rate of requests at a particular type of storage interface, a number of objects representing a particular type of storage resource accessible via a particular type of storage interface, and/or other operational parameters of storage device 610.

In some embodiments, each of storage interface module 643, 645, and/or 647 can expose a unique storage interface related to storage resource represented by an object in object pool module 680. For example, storage interface module 643 can expose an NFS interface (or protocol) for access to a file-based storage resource represented by, for example, storage resource 613 of object pool module 680; storage interface module 645 can expose a FTP interface (or protocol) for access to a file-based storage resource represented by, for example, storage resource 615 of object pool module 680; and storage interface 647 can expose an iSCSI interface (or protocol) for access to a block-based storage resource represented by, for example, storage resource 617 of object pool module 680 based on one or more SCSI command sets such as, SBCs. In some embodiments, storage presentation module 640 can include other and/or additional storage interface modules configured to expose other storage interfaces such as, for example, an iSCSI interface to an object-based interface based on OSD commands, an iSCSI interface to stream-based storage resources such as tapes (or other sequential access storage resource) based on SSCs, an iSCSI interface to a media changer storage resource such as a tape or other media library based on SMC commands, and/or other interfaces.

In some embodiments, a storage interface module can expose more than one storage interface. For example, in some embodiments a storage interface module can expose an iSCSI interface capable of providing access to one or more storage resources based on SBCs, OSD commands, SSCs, and SMC commands. In some embodiments, a storage module can expose a CIFS interface, an FTP interface, and an AFP interface. In some embodiments, a storage module can expose an HTTP interface and a WebDAV interface. In some embodiments, a storage interface module can expose other combination of storage interfaces.

In some embodiments, one or more of storage interface module 643, 645, and 647 can advertise or broadcast a storage interface via network. In other words, one or more of storage interface module 643, 645, and 647 can notify devices operatively coupled to a network of a storage interface or a storage resource accessible via a storage interface at storage device 610.

In some embodiments, each of storage interface module 643, 645, and 647 is related to or associated with a single object representing a storage resource in object pool module 680. In other words, in some embodiments, each storage interface module presents a storage interface to a particular storage resource represented by an object in object pool module 680. Said differently, in some embodiments, there can be a one-to-one mapping or relationship between a storage interface module and a virtual storage resource.

In some embodiments, a storage interface module is not related to a single object representing a storage resource in object pool module 680. Rather, in some embodiments, a storage interface module is exposes or presents an interface to multiple storage resources. In some embodiments, a single storage interface module can expose an interface for to each object in object pool 680 that is accessible via a protocol implemented by that storage interface module. For example, storage interface module 647 can expose an FTP interface by implementing (or conforming to) the file transfer protocol. Storage interface module 647 can be configured to provide access (via mapping module 660) to all the objects in object pool module 680 that represent storage resources accessible via FTP.

In some embodiments, a single storage interface module can provide access to more than one object representing a particular type of storage resource, but not all objects representing that particular type of storage resource. For example, storage interface module 643 can expose an FTP interface, and storage interface module 645 can expose an FTP interface. Storage interface module 643 can provide access (via mapping module 660) to a first sub-set of the objects in object pool module 680 representing storage resources accessible via FTP including, for example, storage resource 613. Similarly, storage interface module 645 can provide access (via mapping module 660) to a second sub-set of the objects in object pool module 680 representing storage resources accessible via FTP including, for example, storage resource 615. In some embodiments, such division of access to objects in object pool module 680 representing a particular type of class of storage resources can result in an improved distribution of processing at the storage interface modules of storage presentation module 640.

Storage presentation module 640 is operatively coupled to mapping module 660. Similar to mapping module 260 discussed with respect to FIG. 2, mapping module 660 is configured to receive the requests for access to storage resources from storage presentation module 640, and convert or map those requests to requests for access to objects in object pool module 680. In some embodiments, an object in object pool module 680 includes attributes and/or other data related to a storage resource represented by that object. For example, an object can include attributes related to formatting, directory structure, logical volumes, and/or other data related to a storage resource represented by the object. In some embodiments, mapping module 680 can access such attributes to map or convert a request for access to a storage resource to a request for access to an object.

As illustrated in FIG. 6, mapping module 660 includes mapping sub-module 663 and mapping sub-module 665. Mapping sub-modules 663 and 665 are each configured to receive requests for access to storage resources from one or more of storage interface modules 643, 645, and 647, and convert or map those requests to requests for access to objects in object pool module 680. Similar to storage interface modules 643, 645, and 647, mapping sub-modules 663 and 665 can be hardware modules, software modules, or a combination of hardware and software modules. P62 illustrates a logical connection between storage interface module 643 and mapping sub-module 663, P64 illustrates a logical connection between storage interface module 645 and mapping sub-module 663, and P66 illustrates a logical connection between storage interface module 647 and mapping sub-module 665. In some embodiments, a logical connection can be a physical connection or a protocol over a physical connection. In some embodiments, a logical connection can be a virtual connection such as a inter-process communication (“IPC”) at a processor or arguments (or values) passed among functions of software modules executing at a processor.

In some embodiments, mapping sub-modules 663 and 665 are each configured to receive requests for access to a particular type of storage resource. Said differently, mapping sub-module 663 can be configured to receive requests for access to one type of storage resources, and mapping sub-module 665 can be configured to receive requests for access to another type of storage resources. For example, mapping sub-module 663 can be configured to convert requests for access to file-based storage resources to requests for access to objects in object pool module 680, and mapping sub-module 665 can be configured to convert requests for access to object-based storage resources to requests for access to objects in object pool module 680. Storage interface module 643 can expose an NFS interface, and storage interface module 645 can expose an HTTP interface. The NFS and HTTP interfaces are file-based (e.g., the NFS protocol and HTTP operate on files) and storage interface modules 643 and 645 can forward or send requests for access to storage resources (which are file-based due to the HTTP and NFS protocol) to mapping sub-module 663 via P62 and P64, respectively. Storage interface module 647 can expose an iSCSI interface for OSD commands. The storage interface exposed by storage interface module 647 is object-based, and storage interface module 647 can forward requests for access to storage resources (which are object-based due to the OSD commands) to mapping sub-module 665 via P66. Thus, mapping sub-module 663 can convert requests for access to file-based storage resources to requests for access to objects in object pool module 680, and mapping sub-module 665 can convert requests for access to object-based storage resources to requests for access to objects in object pool module 680.

In some embodiments, a mapping sub-module can be configured to convert requests for access to various types of storage resources to requests for access to objects in object pool module 680. For example, mapping sub-module 663 can be configured to receive requests for access to block-based storage resources and file-based storage resources. Storage interface module 643 can be configured to expose a block-based storage interface via a network, and storage interface module 645 can be configured to expose a file-based storage interface via the network. Storage interface module 643 can forward requests for access to block-based storage resources received via network interface module 620 to mapping sub-module 663 via logical connection P62. Storage interface module 645 can forward requests for access to file-based storage resources received via network interface module 620 to mapping sub-module 663 via logical connection P64. Mapping sub-module 663 can interpret the requests for access to storage resources received via P62 as requests for access to block-based storage resources, and can convert (or map) those requests to requests for objects in object pool module 680. Similarly, mapping sub-module 663 can interpret the requests for access to storage resources received via P64 as requests for access to file-based storage resources, and can convert (or map) those requests to request for objects in object pool module 680.

As illustrated in FIG. 6, object pool module 680 is operatively coupled to mapping module 660. In some embodiment, mapping module 660 and object pool module 680 are configured to communicate via a single protocol such that the requests for access to various types of storage resources received at mapping module 660 from storage presentation module 640 are mapped to a common protocol for communication between mapping module 660 and object pool module 680. Thus, mapping module 660 can convert each request for access to a storage resource to one protocol for accessing objects in object pool module 680. In some embodiments, use of a single protocol between mapping module 660 and object pool module 680 can simplify design, operation, and/or troubleshooting of mapping module 660, object pool module 680, and/or the interface between mapping module 660 and object pool module 680.

As discussed above, object pool module 680 can include hardware and/or software. In some embodiments, object pool module 680 can include one or more physical object-based storage devices such as, for example, object-based hard disk drives that provide the physical storage for the objects in object pool module 680. In some embodiments, object pool module 680 is in communication with one or more physical object-based storage devices that provide the physical storage for the objects in object pool module 680. In other words, objects that are in object pool module 680 can be located on one or more physical object-based storage devices. Object pool module can include hardware and/or software configured to present or expose the objects stored on the one or more physical object-based storage devices as being located in a common pool or group, rather than located on a particular physical object-based storage devices. Said differently, mapping module 660 can request access to a particular object in object pool module 680 based on, for example, an object ID without specifying the physical object-based storage devices on which that object is located. This abstraction of objects located on one or more physical object-based storage devices into a common object pool can simply access to the objects and management of the object pool.

In some embodiments, storage device 610 includes a management module (not shown) operatively coupled to object pool 680. A management module can be a software module embodied in software or code executable on a processor. In some embodiments, a management module can be a hardware module such as an ASIC or other hardware configured to manage object pool module 680 and/or objects in object pool module 680. In some embodiments, a management module can be a combination of one or more software modules and one or more hardware modules.

In some embodiments, a management module can be operatively coupled to one or more of network interface module 620, storage presentation module 640, mapping module 660, and object pool module 680. For example, in some embodiments, a management module can be operatively coupled to storage presentation module 640 and mapping module 660. Storage presentation module 640 can send requests for access to storage resources to mapping module 660 via the management module. The management module can identify the type of storage resource for which access is requested based on, for example, a protocol implemented by the storage interface module of storage presentation module 640 that received the request. The management module can then forward or route the request to a mapping sub-module of mapping module 660 configured to convert requests of for type of storage resource to request for objects in object pool module 680.

In some embodiments, a management module can be operatively coupled to object pool module 680 such that the management module can provide information lifecycle management (“ILM”) policies such as, for example, data retention, data backup, data de-duplication and shredding of data included in objects in object pool module 680 based on, for example, attributes of the objects in object pool module 680. Additionally, in some embodiments, data security and access policies of objects in object pool module 680 can be managed by a management module. In some embodiments, a management module can communicate with object pool module 680 based on the same protocol used by mapping module 660 to communication with object pool module 680.

In some embodiments, a management module is authorized to request actions with respect to objects in object pool module 680, which mapping module 660 is not authorized to perform. In other words, the management module can provide commands to object pool module 680, and object pool module 680 processes or executes the requests because the management module is authorized or permitted to request such actions. For example, in some embodiments, object pool module 680 can implement or enforce data security policies allowing a management module to request actions such as, for example, data retention, data backup, data de-duplication and shredding of data, while not allowing mapping module 660 to request such actions. Mapping module 660 can be limited to requesting actions related to, for example, reading, writing, and deleting data in objects in object pool module 680. In some embodiments, a management module can be authorized or permitted to request actions related to, for example, reading, writing, and deleting data in objects in object pool module 680. In some embodiments, a management module can be authorized or permitted to, for example, create, manage (e.g., backup, de-duplicate, or clone), or delete objects in object pool module 680.

In some embodiments, a management module can be accessible to an administrator of storage device 610 using, for example, a remote login or access program or protocol via network interface module 620 or another interface such as a serial interface. For example, an administrator can access the management module via a remote login to define or upload policies for ILM, to manually request actions in object pool module 680 with respect to objects in object pool module 680, and/or otherwise manage storage device 610 and/or object pool module 680.

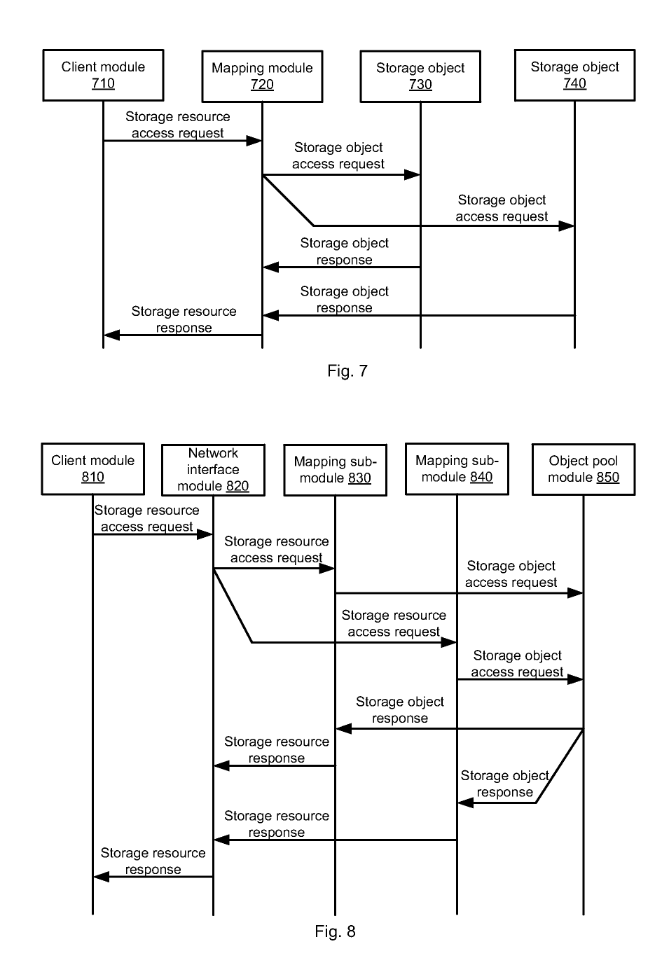

FIG. 7 illustrates a communication flow for providing access in a multiple-protocol object-based storage device to data related to a storage resource, according to an embodiment. As illustrated in FIG. 7, client module 710 (e.g., a client of a multiple-protocol object-based storage device) can communicate with mapping module 720 to access storage resources represented by or contained within storage object 730 and/or storage object 740.

Client module 710 sends a storage resource access request to mapping module to request access to a storage resource (or data in the storage resource). As discussed above with respect to FIGS. 2 and 6, client module 710 can send the storage resource access request to a storage device including mapping module 720 based on a protocol of a storage interface exposed by the storage device. Mapping module 720 receives the storage resource access request, and determines the type of which storage object (e.g., which object in a object pool module) contains data related to the storage resource to which client module 710 has requested access. For example, the storage resource access request can include an identifier of the storage resource such as a name or storage resource number, and mapping module 720 can lookup an object ID of an object in an object pool module that represents that storage resource in a database or table. In some embodiments, an object ID can be extracted from an identifier of a storage resource. For example, a storage resource number can be a 64-bit number and a hash value based on that 64-bit number can be an object ID.

In some embodiments, mapping module 720 also formats (or reformats) the storage resource access request into a storage object access request. In other words, mapping module 720 defines a request for access to a storage object that conforms to a protocol for communication with an object pool module from the storage resource request. Mapping module 720 sends the storage object access request and the object ID (in some embodiments, the object ID can be included in the storage object access request) to storage object 730 or storage object 740 based on the object ID. In some embodiment, mapping module 720 sends the storage object access request to an object pool module, and the object pool module accesses one of storage object 730 or storage object 740 based on the object ID.

The storage object access request can be a request to, for example, read data, write data, modify an attribute of a storage resource represented by a storage object, read an attribute of a storage resource represented by a storage object, and/or some other data access. After one of storage object 730 and storage object 740 has been accessed based on the storage object access request, a storage object response is sent to mapping module 720. The storage object response can include data read from the storage object, and indication that a write operation was successful or partially successful, an indication that access failed, a status code indicating a cause or possible cause of failed access, an indication that an operation was committed and is complete, and/or other responses. In some embodiments, the storage object response is formatted according to a protocol for communication with a storage object or an object pool module.

Mapping module 720 receives the storage object response and provides a response to client module 710 formatted according to the protocol via which client module 710 sent the storage resource access request. In some embodiments, if the storage object request indicates, for example, that an access request failed or that a storage object or object pool module was busy or unavailable, mapping module 720 can resend a storage object request to attempt to complete the storage resource access request and not report a failure to client module 710. If the subsequent attempt is successful, mapping module 720 can report successful completion of the storage resource access request to client module 710.

FIG. 8 illustrates another communication flow for providing access in a multiple-protocol object-based storage device to data related to a storage resource, according to another embodiment. As illustrated in FIG. 8, client module 810 can send a storage resource access request to a storage device, and the storage resource access request can be received by network interface module 820 of the storage device. Network interface module 820 can determine what type of storage resource is requested based on, for example, the protocol via which the storage resource access request was received. Network interface module 820 can forward the storage resource access request to one of mapping sub-module 830 and mapping sub-module 840 based on the type of storage resource requested. For example, requests for access to file-based storage resources can be forwarded to mapping sub-module 830, and requests for access to block-based storage resources can be forwarded to mapping sub-module 840.

Mapping sub-modules 830 and 840 can covert the storage resource access request to a storage object access request and send the storage object access request to object pool module 850. In other words, mapping sub-modules 830 and 840 can format the information included in the storage resource access request into a format that conforms to a protocol via which mapping sub-modules 830 and 840 can communicate with object pool module 850.

Object pool module 850 processes the storage object access request and provides a storage object response to the mapping sub-module (830 or 840) that sent the storage object access request. Similar to the storage object response discussed with respect to FIG. 7, the storage object access request can indicate various outcomes or results of the storage object access request. The mapping sub-module (830 or 840) that receives the storage object response can convert the response from a format conforming the a protocol for communication with object pool module 850 to a format (referred to as the storage resource response) conforming to the protocol via which client module 810 sent the storage resource access request, and send the storage resource response to network interface module 820. Network interface module 820 can then forward the storage resource response to client module 810 to indication a result or outcome of the storage resource access request.

In some embodiments, network interface module 820, mapping sub-module 830, and/or mapping sub-module 840 can resend a storage resource access request or storage object access request to object pool module 850 if a storage object response or a storage resource response indicates that the storage resource access request failed or could not be processed. In some embodiments, network interface module 820, mapping sub-module 830, and/or mapping sub-module 840 can resend a storage resource access request or storage object access request a predefined number of times before reporting a failure, error, or other response indicating that the storage resource access request was not successful at object pool module 850.

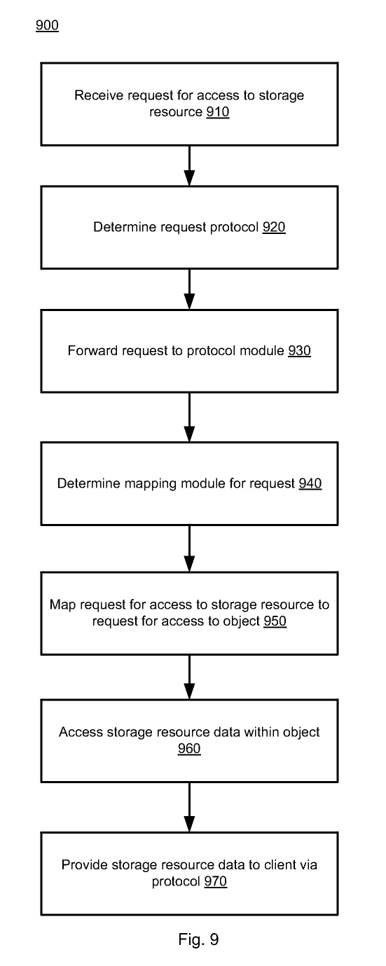

FIG. 9 is a block diagram of process 900 for multiple-protocol access to object-based storage, according to an embodiment. Process 900 can be, for example, implemented as software code on a processor- or computer-readable medium such as a CD-ROM or DVD-ROM, and executed at a processor within a network appliance. In some embodiments, such a network appliance can include a group of object-based storage devices. In some embodiments, a group of object-based storage device can be accessible to such a network appliance via, for example, a network or a data connection (e.g., an external Serial AT Attachment (“eSATA”) connection).

A request for access to a storage resource is received at 910. The request can be received from, for example, a computer terminal via a network, and is formatted based on a protocol for communication with the storage object. In some embodiments, the request can be to read data. In some embodiments, the request can be to write data. In some embodiments, the request can be to create a file or directory within a storage resource that is represented by an object in an object pool. In some embodiments, the request can be to create a storage resource such as a logical volume, disk, tape, tape library, and/or other storage resource. Such a storage resource can be created as a virtual storage resource within an object in an object pool. In some embodiments, the request can be to remove, delete, or destroy a virtual storage resource from an object in an object pool. In other embodiments, the request can be for other actions or processing of a storage resource represented (or virtualized) by an object in an object pool.

In some embodiments, the request is received at a network interface module such as a NIC or other network adapter and the request protocol is determined at 920. The request protocol can be determined based on, for example, a transmission control protocol (“TCP”) port or user (or universal) datagram packet (“UDP”) port at which the request was received. In some embodiments, a field such as a header field in a data packet including the request or a portion of the request can indicate the protocol. In some embodiments, the request can include an identifier of the protocol such as a textual name, a protocol identification number, or some other indication of the protocol.

The request is then forwarded to a protocol module such as, for example, a storage presentation module based on the protocol at 930. A mapping or conversion for the request is then determined based on the protocol at 940. For example, a protocol module can determine a mapping module to which the request should be forwarded such that the mapping module can convert the request from a format conforming to a protocol via which the request was received into a format conforming to a protocol for communication with an object in an object pool.

The request is forwarded to a mapping module, and the request for access to a storage resource is mapped (or converted or reformatted) to a request for access to an object at 950. For example, the request for access to a storage resource can be mapped to a request for access to an object representing (or containing the data of) that storage resource in an object pool. The request can be mapped based on any of a number of methods. For example, a mapping module can include a template of each format conforming to protocols for requests for access to storage resource which the mapping module is configured to receive. Each template can indicate to which portions of the request in the format for communication with an object in an object pool the portions of the request in the format associated with that template correspond. In other words, a request formatted as received, at 910, can include a group of fields, each field having a value. Similarly, a request formatted according to a protocol for communication with an object in an object pool (or with the object pool itself) can have a group of fields. A template can define into which fields in the request formatted according to a protocol for communication with an object in an object pool the values in the fields of the request formatted as received, at 910, should be inserted.

In some embodiments, the request can be self-describing or partially self-describing. For example, a request for access to a storage resource can be formatted using extensible markup language (“XML”). Fields in an XML document can specify an identifier or name of a field. In some embodiments, a mapping module can interpret the identifiers of such fields (or field identifiers) and construct a request for access to an object based on the field identifier in the request.

After the request is converted to conform to the protocol for communication with the object pool, at 950, the request is sent to the object pool to access the storage resource represented by an object in the object pool, at 960. The object pool processes the request and provides a response or result. The response or result can vary based on the request. For example, the response can include data read from an object, an indication that a write or commit operation was successful, an indication that the access was denied or failed, and/or other results of the request. After the response is received, the response (or storage resource data) is provided to the client, at 970, via the protocol via which the request for access to the storage resource was received, at 910.

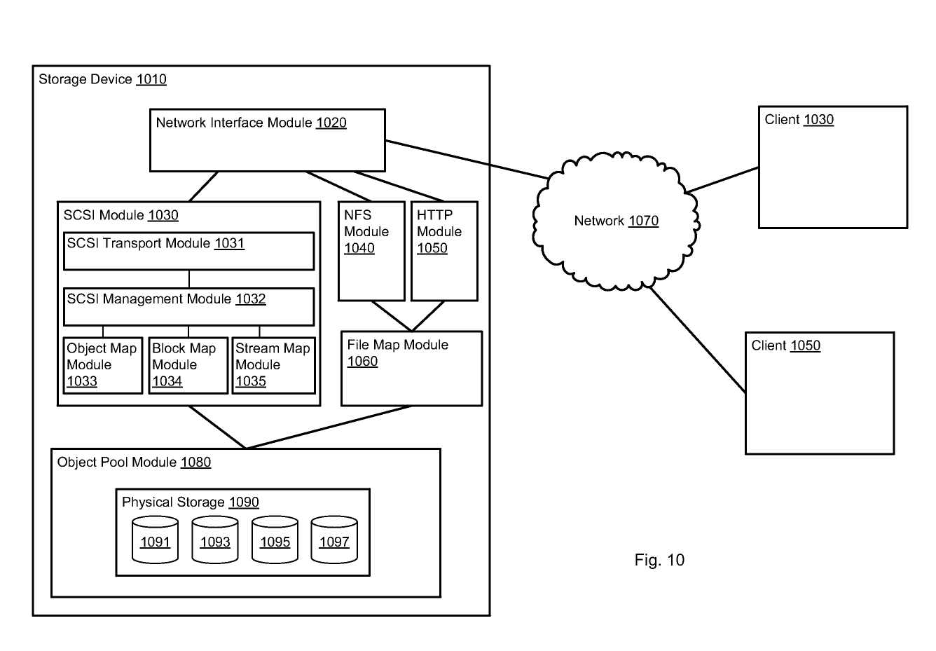

FIG. 10 is a system block diagram of another multiple-protocol object-based storage device in communication with a group of clients via a network, according to another embodiment. As illustrated in FIG. 10, clients 1030 and 1050 can access objects in object pool module 1080 or storage device 1010 via network 1070. Object pool module 1080 includes physical storage 1090. Physical storage 1090 includes object-based storage devices 1091, 1093, 1095, and 1097. Physical storage 1090 and object-based storage devices 1091, 1093, 1095, and 1097 are configured to provide an object-based interface to data stored on object-based storage devices 1091, 1093, 1095, and 1097.

Storage device 1010 exports or presents a variety of storage interfaces to clients 1030 and 1050 including an HTTP interface from HTTP module 1050, an NFS interface via NFS module 1040, and an object-based SCSI interface, a block-based SCSI interface, and a stream-based SCSI interface via SCSI transport module 1031. SCSI transport module 1031 can export, for example, an iSCSI interface and SCSI management module 1032 can include OSD, SBC, and SSC modules to implement an object-based SCSI interface, a block-based SCSI interface, and a stream-based SCSI interface, respectively, over the iSCSI interface. In other words, SCSI module 1030 can export a variety of storage interfaces. In some embodiments, other interfaces such as, for example, a CIFS interface and/or an FTP interface can be exposed by storage device 1010.

SCSI module 1030, NFS module 1040, and HTTP module 1050 are operatively coupled to network interface module 1020 such that the interfaces exported by SCSI module 1030, NFS module 1040, and HTTP module 1050 are accessible to clients 1030 and 1050 via network 1070. In other words, SCSI module 1030, NFS module 1040, and HTTP module 1050 are examples of storage presentation modules. In some embodiments, SCSI module 1030, NFS module 1040, and HTTP module 1050 can be referred to as storage interface modules. For example, SCSI module 1030, NFS module 1040, and HTTP module 1050 can be separate storage presentations modules or portions of a common storage presentation module.

NFS module 1040 and HTTP module 1050 export interfaces that are file-based. In other words, the protocols associated with NFS module 1040 and HTTP module 1050 are file-based. Accordingly, NFS module and HTTP module are operatively coupled to file map module 1060. File map module 1060 is configured to receive requests for access to file-based storage resources from NFS module 1040 and HTTP module 1050, and convert those requests to requests for access to objects in object pool module 1080. In some embodiments, file map module 1060 can be implemented as or embodied in a standard virtual file system (“VFS”) with a standard application programming interface (“API”) such that software or code configured to access data via the VFS can access objects in object pool module 1080 without changes to that software or code. For example, HTTP module 1050 can be a web server application that is configured (e.g., written and compiled) to access data in a traditional block-based file system via a VFS. That VFS can be modified to convert the requests for access to the traditional block-based storage resource (e.g., the file system) into requests for access to objects in object pool module 1080 that virtualize traditional block-based storage resources, without changing the API of the VFS. Thus, the web server application can access object storage resources in object pool module 1080 without any modification. Additionally, other software configured to access data in a traditional block-based file system via a VFS can access object storage resources in object pool module 1080 without any modification. For example, many software applications configured to access data in a traditional block-based file system via the Portable Operating System Interface (“POSIX”) VFS can access object storage resources in object pool module 1080 with only modification of an implementation of POSIX VFS. In other words, NFS module 1040, HTTP module 1050, and/or other storage presentation modules or storage interface modules need not be specifically configured to access data in objects in object pool module 1080.

Similarly, OSD, SBC, SSC, and/or other SCSI modules in SCSI management module 1032 can be configured to access storage resources such as traditional block-based storage resources, and can access object storage resources in object pool module 1080 via object map module 1033, block map module 1034, and stream map module 1035. Thus, storage presentation modules and storage interface modules can, for example, store and retrieve data from objects in object pool module 1080 using commands and protocols that are native to storage resources virtualized by the objects in object pool module 1080. Furthermore, clients 1030 and 1050 can, for example, store and retrieve data from objects in object pool module 1080 using commands and protocols that are native to storage resources virtualized by the objects in object pool module 1080. Accordingly, applications and clients can take advantage of benefits of object-based storage without altering their behavior or configuration.

In some embodiments, modules such as a storage presentation module, storage interface module, or command modules (e.g., OSD, SBC, SSC, and/or other SCSI modules) can be loaded or activated dynamically. For example, a management module can receive a command or request (e.g., from an administrator or from a client or user of a storage device) for access to data in a storage resource stored in an object in an object pool using a particular protocol. The management module can, for example, load (or move) a software module into memory and cause the software module to be executed at a processor to receive requests for access to the storage resource via the protocol. In some embodiments, the software module can provide a memory address (or location or pointer) to a table located in the memory into which the software module is loaded. In some embodiments, the loading and receiving of a memory address of a table can be referred to as registering a module. The table can include instructions (e.g., pointers to software routines or commands) that can be accessed to process requests for access to the storage resource received via the protocol. In some embodiments, a module can be registered for each object in the object pool that is accessible via a protocol. That is, in some embodiment, there is a one-to-one relationship between a module and an object in an object pool. In some embodiments, a module can be registered for a group of objects in the object pool.

Some embodiments described herein relate to a computer storage product with a computer-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described. For example, in some embodiments, features of one module described herein can be included in another module to reduce the number of discrete components of an apparatus. Additionally, in some embodiments, for example, some modules described herein can be implemented in software or code executing on a processor and other modules can be implemented in hardware such as application-specific integrated circuits or semiconductor chips.

What is claimed is:

1. An apparatus, comprising:
a storage presentation module operable to provide a first storage interface and a second storage interface via a network interface, the first storage interface associated with a first storage resource accessible via a first storage protocol, the second storage interface associated with a second storage resource accessible via a second storage protocol different from the first storage protocol; and
a mapping module in communication with the storage presentation module, the mapping module further in communication with an object pool module,
the mapping module operable to receive from the storage presentation module a request for access to the first storage resource based on the first storage protocol and a request for access to the second storage resource based on the second storage protocol,
the mapping module operable to convert the request for access to the first storage resource into a request for access to a first object in the object pool module, the first object being associated with the first storage resource,
the mapping module operable to convert the request for access to the second storage resource into a request for access to a second object in the object pool module, the second object being associated with the second storage resource.

2. The apparatus of claim 1, wherein:
the first storage interface is a file-based storage interface, the first storage resource is a file-based storage resource, and the first storage protocol is a file-based storage protocol; and
the second storage interface is a block-based storage interface, the second storage resource is a block-based storage resource, and the second storage protocol is a block-based storage protocol.

3. The apparatus of claim 1, wherein:
the first storage interface is an object-based storage interface, the first storage resource is an object-based storage resource, and the first storage protocol is an object-based storage protocol; and
the second storage interface is a block-based storage interface, the second storage resource is a block-based storage resource, and the second storage protocol is a block-based storage protocol.

4. The apparatus of claim 1, wherein the mapping module is operable to provision the first object in the object pool module and the second object in the object pool based on a single object management protocol.

5. The apparatus of claim 1, wherein:
the first storage interface is a sequential storage interface, the first storage resource is a sequential storage resource, and the first storage protocol is a sequential storage protocol; and
the second storage interface is a block-based storage interface, the second storage resource is a block-based storage resource, and the second storage protocol is a block-based storage protocol.

6. The apparatus of claim 1, wherein:
the mapping module includes a first mapping sub-module and a second mapping sub-module,
the first mapping sub-module operable to convert the request for access to the first storage resource into the request for access to the first object in the object pool module, the first object being associated with the first storage resource,
the second mapping sub-module operable to convert the request for access to the second storage resource into a request for access to a second object in the object pool module, the second object being associated with the second storage resource.

7. A method, comprising:
accessing a first data set in a first object within an object pool based on a first storage protocol command, the first object being associated with a first storage resource;
accessing a second data set in a second object within the object pool based on a second storage protocol command, the second object being associated with a second storage resource;
providing the first data set to a storage presentation module as data included in the first storage resource via a first storage protocol, the storage presentation module configured to provide via a network a first storage interface to the first data set; and
providing the second data set to the storage presentation module as data included in the second storage resource via a second storage protocol, the storage presentation module configured to provide via the network a second storage interface to the second data set.

8. The method of claim 7, further comprising:
provisioning the first object based on the accessing a first data set in the first object; and
provisioning the second object based on the accessing the second data set in the second object.

9. The method of claim 7, further comprising:
provisioning the first object before the accessing the first data set in the first object based on a request for provisioning the first storage resource.

10. The method of claim 7, wherein:
the first storage resource is a virtual storage resource represented by the first object; and
the second storage resource is a virtual storage resource represented by the second object.

11. The method of claim 7, wherein:
the first storage interface is an object-based storage interface, the first storage protocol is an object-based storage protocol, and the first storage resource is a virtual object-based storage resource; and
the second storage interface is a block-based storage interface, the second storage protocol is a block-based storage protocol, and the second storage resource is a virtual block-based storage protocol.

12. The method of claim 7, wherein:
the first storage interface is an sequential storage interface, the first storage protocol is a sequential storage protocol, and the first storage resource is a virtual sequential storage resource; and
the second storage interface is an object-based storage interface, the second storage protocol is an object-based storage protocol, and the second storage resource is a virtual object-based storage resource.

13. The method of claim 7, further comprising:
accessing a third data set in a third object within the object pool based on a third storage protocol command, the third object being associated with a third storage resource;
accessing a fourth data set in a fourth object within the object pool based on a fourth storage protocol command, the fourth object being associated with a fourth storage resource;
providing the third data set to a storage presentation module as data included in the third storage resource via a third storage protocol, the storage presentation module configured to provide via a network a third storage interface to the third data set; and
providing the fourth data set to the storage presentation module as data included in the fourth storage resource via a fourth storage protocol, the storage presentation module configured to provide via the network a fourth storage interface to the fourth data set.

14. An apparatus, comprising:
a block-based interface module configured to provide a first block-based storage interface and a second block-based storage interface via a network;
a file-based interface module configured to provide a first file-based storage interface and a second file-based storage interface via the network; and
a mapping module operatively coupled to the block-based interface module, the mapping module further operatively coupled to the file-based interface module,
the mapping module configured to access a first plurality of objects in an object pool based on block-based protocol commands received from the block-based interface module,
the mapping module configured to access a second plurality of objects in the object pool based on file-based protocol commands received from the file-based interface module,
the first plurality of objects and the second plurality of objects commonly managed in the object pool.

15. The apparatus of claim 14, further comprising an object-based storage interface module configured to provide an object-based storage interface via the network; and wherein:
the mapping module is configured to access a third plurality of objects in the object pool based on object-based protocol commands received from the object-based interface module; and
the first plurality of objects, the second plurality of objects, and the third plurality of objects are commonly managed in the object pool.

16. The apparatus of claim 14, wherein:
the mapping module is configured to access the first plurality of objects in the object pool using an object-based protocol; and
the mapping module is configured to access the second plurality of objects in the object pool using the object-based protocol.

17. The apparatus of claim 14, wherein:
the mapping module is configured to provide to the block-based storage module access to each object in the first plurality of objects in the object pool as a block-based storage resource; and
the mapping module is configured to provide to the file-based storage module access to each object in the second plurality of objects in the object pool as a file-based storage resource.

18. The apparatus of claim 14, wherein:
the first block-based storage interface is associated with a first block-based storage resource;
the second block-based storage interface is associated with a second block-based storage resource;
the first file-based storage interface is associated with a first file-based storage resource; and
the second file-based storage interface is associated with a second file-based storage resource.

19. The apparatus of claim 14, wherein:
the mapping module is configured to provision each object from the first plurality of objects as a storage resource based on a block-based protocol command; and
the mapping module is configured to provision each object from the second plurality of objects as a storage resource based on a file-based protocol command.

20. The apparatus of claim 14, wherein:
the mapping module includes a first mapping sub-module and a second mapping sub-module,
the first mapping sub-module configured to access the first plurality of objects in the object pool based on block-based protocol commands received from the block-based interface module,
the second mapping sub-module configured to access the second plurality of objects in the object pool based on file-based protocol commands received from the file-based interface module.
